(19) United States
(12) Patent Application Publication
(10) Pub. No.: US 2026/0340749 A1
(43) Pub. Date: Oct. 29, 2026

(54) NEGOTIATION SUPPORT DEVICE, METHOD, AND STORAGE MEDIUM

(71) Applicant: NEC Corporation, Tokyo (JP)

(72) Inventor: Tomohito ANDO, Tokyo (JP)

(73) Assignee: NEC Corporation, Tokyo (JP)

(21) Appl. No.: 19/646,876

(22) Filed: Apr. 14, 2026

(30) Foreign Application Priority Data
Apr. 25, 2025 (JP) 2025-073426

(51) Int. Cl. G06Q 50/18

(52) U.S. Cl. CPC G06Q 50/188

(57) ABSTRACT

A negotiation support device 1X mainly includes an acquisition means 32X, a generation means 30X, and a notification means 31X. The acquisition means 32X acquires a first offer proposed by a first negotiation subject to a second negotiation subject. The generation means 30X generates, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set. The notification means 31X notifies the first negotiation subject of the second offer.

### INCORPORATION BY REFERENCE

This application is based upon and claims the benefit of priority from Japanese Patent Application No. 2025-073426, filed on April 25, 2025, the disclosure of which is incorporated herein in its entirety by reference.

### TECHNICAL FIELD

The present disclosure relates to a technical field of a negotiation support device, a method, and a storage medium.

### BACKGROUND

A system that automatically performs negotiations regarding adjustment of conditions between an ordering side and a receiving side is known. For example, Patent Literature 1 discloses an automatic negotiation system that stores in advance negotiation candidates for an assumed order from an ordering side, and sends the negotiation candidates to the ordering side while prioritizing those having the highest utility to a negotiation condition received from the ordering side.

### CITATION LIST

### PATENT LITERATURE

Patent Literature 1: WO 2021/024414 A1

### SUMMARY

In a case where a request for due date adjustment is received, depending on the inventory schedule status at the time of request, it may not be clear when an item to be subjected to due date adjustment can be delivered. In this case, if the answer is suspended without responding to the request, the negotiation partner may doubt whether the information has been received or whether the counterpart has started consideration.

In view of the above problem, an object of the present disclosure is to provide a negotiation support device, a method, and a program capable of flexibly executing due date adjustment.

One aspect of a negotiation support device is a negotiation support device comprising: an acquisition means for acquiring a first offer proposed by a first negotiation subject to a second negotiation subject; a generation means for generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and a notification means for notifying the first negotiation subject of the second offer.

Another aspect of a negotiation support device is a negotiation support device comprising: an acquisition means for acquiring an offer proposed by a second negotiation subject to a first negotiation subject; and a specifying means for specifying, in a case where the offer includes an adjustment item for which a due date that is a predetermined period or more ahead of current time is set or an adjustment item for which a flag indicating that the due date is a provisional due date is set, that the provisional due date is set for the adjustment item.

One aspect of a method is a method comprising, by a computer: acquiring a first offer proposed by a first negotiation subject to a second negotiation subject; generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and notifying the first negotiation subject of the second offer.

Another aspect of a method is a method comprising, by a computer: acquiring an offer proposed by a second negotiation subject to a first negotiation subject; and specifying, in a case where the offer includes an adjustment item for which a due date that is a predetermined period or more ahead of current time is set or an adjustment item for which a flag indicating that the due date is a provisional due date is set, that the provisional due date is set for the adjustment item.

One aspect of a storage medium is a non-transitory computer readable storage medium storing a program causing a computer to execute a process comprising: acquiring a first offer proposed by a first negotiation subject to a second negotiation subject; generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and notifying the first negotiation subject of the second offer.

Another aspect of a storage medium is a non-transitory computer readable storage medium storing a program causing a computer to execute a process comprising: acquiring an offer proposed by a second negotiation subject to a first negotiation subject; and specifying, in a case where the offer includes an adjustment item for which a due date that is a predetermined period or more ahead of current time is set or an adjustment item for which a flag indicating that the due date is a provisional due date is set, that the provisional due date is set for the adjustment item.

As an example of the effect according to the present disclosure, it is possible to flexibly proceed with due date adjustment.

### BRIEF DESCRIPTION OF THE DRAWINGS

FIG. 1 illustrates a configuration of a negotiation system.

FIG. 2 illustrates a hardware configuration of a platform providing device.

FIG. 3 illustrates a hardware configuration of a terminal device.

FIG. 4 is an example of functional blocks in a negotiation platform.

FIG. 5A is a table illustrating an offer history in a first specific example in which a negotiation subject A proposes an offer including order numbers “P000125” and “P000126” to a negotiation subject B. FIG. 5B is a table illustrating an offer history in the first specific example after a counter offer by the negotiation subject B is proposed.

FIG. 6A is a table illustrating an offer history in a second specific example in which the negotiation subject B proposes an offer including order numbers “P000125” and “P000126” to the negotiation subject A. FIG. 6B is a table illustrating an offer history in the second specific example in a case where a negotiation AI of the negotiation subject A generates a counter offer. FIG. 6C is a table illustrating an offer history according to a comparative example of the second specific example in a case where the negotiation AI of the negotiation subject A generates a counter offer.

FIG. 7 is an example of a flowchart illustrating a procedure of processing related to acceptance determination of an offer and generation of a counter offer by the negotiation AI in a case where the negotiation subject B, which is a supplier, performs negotiations by the negotiation AI.

FIG. 8 is an example of a flowchart illustrating a procedure of processing related to acceptance determination of an offer and generation of a counter offer by the negotiation AI in a case where the negotiation subject A, which is a buyer, performs negotiations by the negotiation AI.

FIG. 9 illustrates a configuration of a negotiation system.

FIG. 10 is a functional block diagram of a negotiation support device.

FIG. 11 is an example of a flowchart illustrating a processing procedure of the negotiation support device.

### EXAMPLE EMBODIMENTS

Hereinafter, example embodiments of a negotiation support device, a method, and a program will be described with reference to the drawings.

In the following description, a “negotiation” refers to adjustment regarding conditions until an agreement is reached between both parties placing and receiving an order (that is, giving and receiving an order). In the present example embodiment, the “negotiation” mainly refers to an act in which both parties placing and receiving an order alternately provide an agreement candidate proposal of the condition regarding the order (which is also referred to as an “offer”) until an agreement is reached. The negotiation in this case may be a negotiation between subjects having conflicting interests or a negotiation (i.e., adjustment) between subjects having no conflicting interests. In addition, the negotiation includes not only a negotiation related to a general order issuing an order sheet but also a negotiation for adjusting a scheduled delivery quantity or the like without issuing an order sheet. Examples of the conditions (so-called issues) on which the negotiation is performed include the price, due date, quantity, transportation means, use resources (airspace in a case where the transportation means is a drone), function, quality, and the like of an item. A “negotiation subject” is a subject that places and receives an order, and refers to, for example, a subject having an ability to generate an agreement candidate proposal to be provided to another negotiation subject and an ability to determine whether to agree to an offer acquired from the another negotiation subject. The negotiation subject may be an individual or may be an organization. The negotiation subject may negotiate using AI, a robot, or other devices (including a drone and an autonomous vehicle) reflecting the intention of the individual or organization.

### First Example Embodiment

### System Configuration

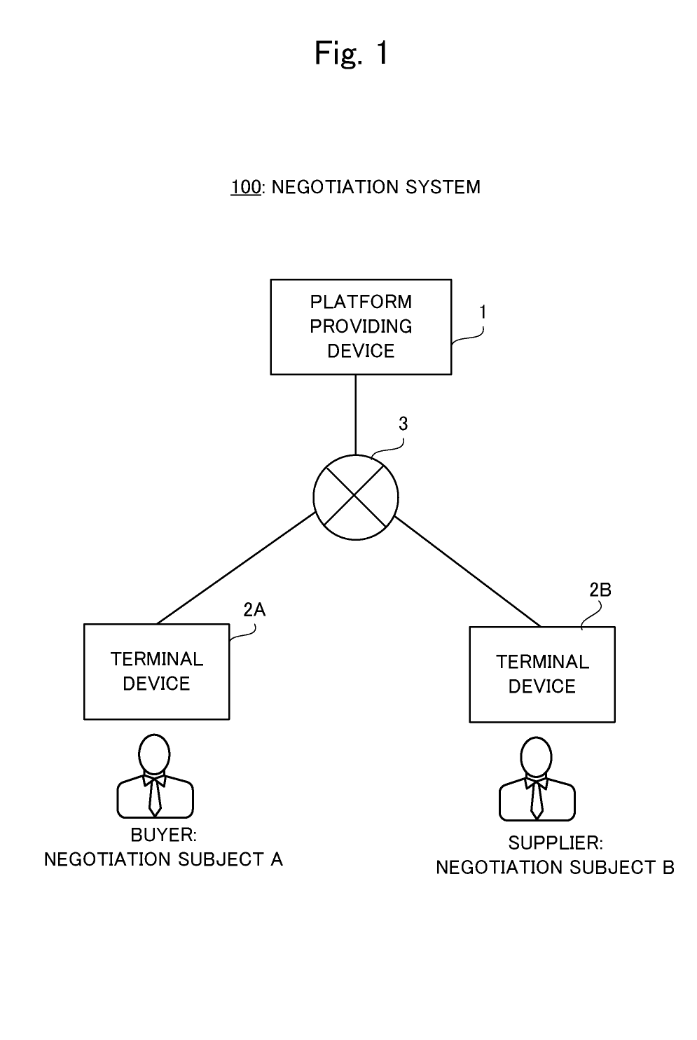

FIG. 1 illustrates a configuration of a negotiation system 100. The negotiation system 100 mainly includes a platform providing device 1 that provides an electronic negotiation platform for negotiating conditions, and a terminal device 2A and a terminal device 2B used by a negotiation subject that performs negotiations on the negotiation platform provided by the platform providing device 1. The platform providing device 1, the terminal device 2A, and the terminal device 2B perform data communication via a network 3. FIG. 1 illustrates, as an example, the terminal device 2A used by a negotiation subject A, which is a buyer who purchases parts necessary for manufacturing a product, and the terminal device 2B used by a negotiation subject B, which is a supplier who supplies the parts. Hereinafter, when not being particularly distinguished from each other, the terminal device 2A and the terminal device 2B are also simply referred to as the “terminal device 2”.

Hereinafter, a one-to-one negotiation between the negotiation subject A and the negotiation subject B will be described as an example. Here, multiple one-to-one negotiations to be described below may be combined to be developed into competitive quotation negotiations, total volume negotiations, and nested negotiations.

The platform providing device 1 provides a negotiation platform necessary for the negotiation subject A and the negotiation subject B to negotiate conditions via the terminal device 2A and the terminal device 2B. In the present example embodiment, the negotiation subject A is a buyer (purchaser) who purchases parts necessary for manufacturing a product, and the negotiation subject B is a supplier who supplies the parts. The platform providing device 1 generates display information necessary for displaying information necessary for negotiations, and transmits the generated display information to the terminal device 2A and the terminal device 2B, thereby controlling the display of the terminal device 2A and the terminal device 2B. In this case, the platform providing device 1 receives input information regarding an offer from the terminal device 2A and the terminal device 2B, and generates the above display information based on the received input information. The platform providing device 1 is an example of a “negotiation support device”.

The terminal device 2 (2A, 2B) is a communication device that can be used by the negotiation subject, and displays information or accepts an input by the negotiation subject who uses the device, based on data communication with the platform providing device 1. In the present example embodiment, as an example, assume that at least one of the negotiation subject A and the negotiation subject B can perform automatic negotiations using negotiation AI (the negotiation AI will be described later). On the other hand, a negotiation subject not performing the automatic negotiations by the negotiation AI performs negotiations based on an input via the terminal device 2B by a person in charge (hereinafter, it is also referred to as “manual negotiations”). Note that, in a case where it is determined that an agreement is not reached in the automatic negotiations by the negotiation AI, or in other cases where it is determined that manual negotiations are needed, the negotiation subject performing the automatic negotiations by the negotiation AI can switch it to the manual negotiations.

The configuration of the negotiation system 100 illustrated in FIG. 1 is an example, and various changes may be made to the configuration. For example, the platform providing device 1 may include multiple devices. In this case, the multiple devices constituting the platform providing device 1 exchange information necessary for executing processing allocated in advance between the multiple devices.

### Hardware Configuration

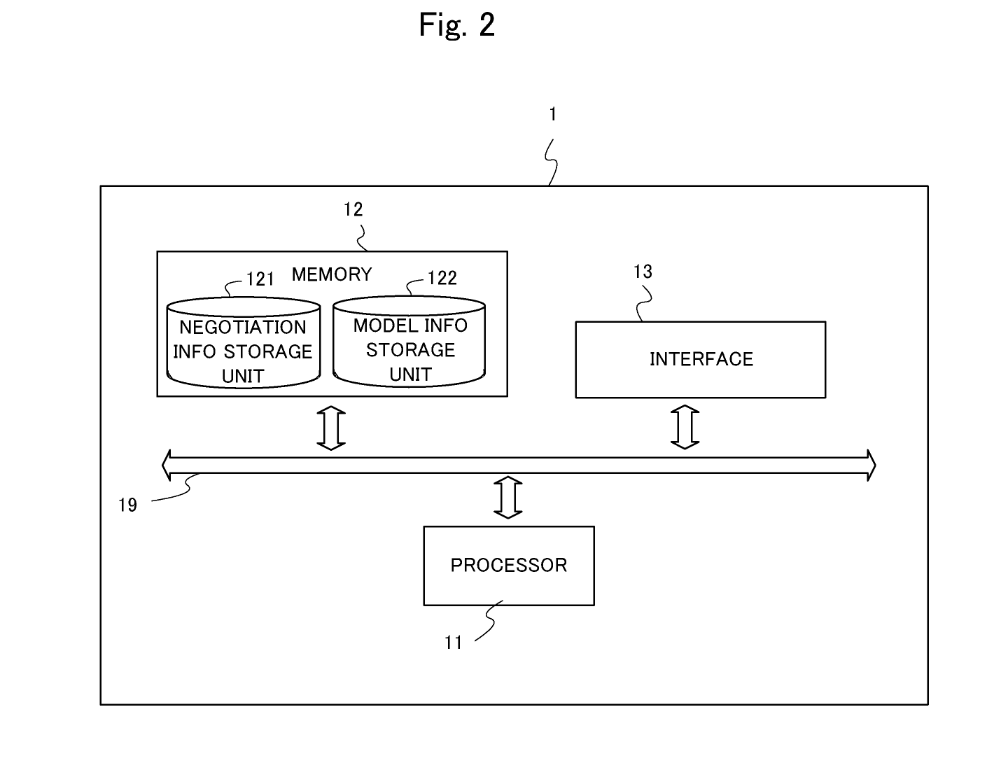

FIG. 2 illustrates a hardware configuration of the platform providing device 1. The platform providing device 1 includes a processor 11, a memory 12, and an interface 13 as hardware. The processor 11, the memory 12, and the interface 13 are connected via a data bus 19.

The processor 11 executes predetermined processing by executing a program stored in the memory 12. The processor 11 is a processor such as a central processing unit (CPU), a graphics processing unit (GPU), or a tensor processing unit (TPU). The processor 11 may include multiple processors. The processor 11 is an example of a computer.

The memory 12 includes various volatile memories and nonvolatile memories, such as a random access memory (RAM), and a read only memory (ROM). The memory 12 stores a program for the platform providing device 1 to execute various types of processing. The memory 12 is also used as a working memory.

The memory 12 functionally includes a negotiation information storage unit 121 and a model information storage unit 122.

The negotiation information storage unit 121 stores negotiation information that is information regarding negotiations between the negotiation subject A and the negotiation subject B. The negotiation information includes information regarding an offer currently agreed between the negotiation subject A and the negotiation subject B (that is, a draft agreement before negotiation). For example, an order number may be assigned to an item to be delivered (that is, an item that is a target of order receipt and order placement) according to a type of the item or the like. In this case, the offer indicates a proposed condition related to multiple order numbers, and a proposed condition for each order number is equivalent to an adjustment item to be adjusted between the negotiation subjects.

The model information storage unit 122 stores model information (including parameters) for configuring the negotiation AI, which is an artificial intelligence model that performs negotiations regarding an offer as a proxy of the negotiation subject. The negotiation AI is used for a negotiation subject that is a human or an organization to negotiate with another negotiation subject.

The negotiation AI has an acceptance strategy function of determining whether an offer provided by another negotiation subject can be agreed (so-called acceptance determination), an offer generation function of generating an offer, and the like. Note that, generation of an offer includes generation of an alternative offer (also referred to as a “counter offer”) in a case where it is determined that an offer provided by another negotiation subject cannot be agreed. For generation of an offer, any method such as beam search, grid search, search by stochastic optimization based on a genetic algorithm or the like, search by Bayesian optimization, or a combination thereof may be used. In addition, the negotiation AI may calculate utility using a utility function that calculates the degree of desirability of order receipt or order placement, and perform acceptance determination of an offer from the counterpart negotiation subject and determine an offer to be notified to the counterpart negotiation subject based on the utility. For example, the negotiation AI may carry out an acceptance strategy of accepting an offer having utility equal to or greater than a predetermined threshold value and not accepting an offer having utility less than the above-described threshold value. Further, the negotiation AI may determine an offer to be notified to another negotiation subject in descending order of utility. An offer determination method based on the utility function is disclosed in, for example, WO 2021/024414 A1.

The interface 13 is an interface for electrically connecting the platform providing device 1 and another device. This interface may be a wireless interface such as a network adapter for wirelessly transmitting and receiving data to and from the another device, or may be a hardware interface for connecting to the another device by a cable or the like.

A hardware configuration of the platform providing device 1 is not limited to the configuration illustrated in FIG. 2. For example, the platform providing device 1 may include at least one of an input device, a display device, and a sound output device. Further, at least a part of information stored in the memory 12 may be stored in one or multiple storage devices other than the platform providing device 1. In this case, the storage device may be a hard disk connected to the platform providing device 1, may be a storage medium such as a flash memory, or may be a server device that performs data communication with the platform providing device 1.

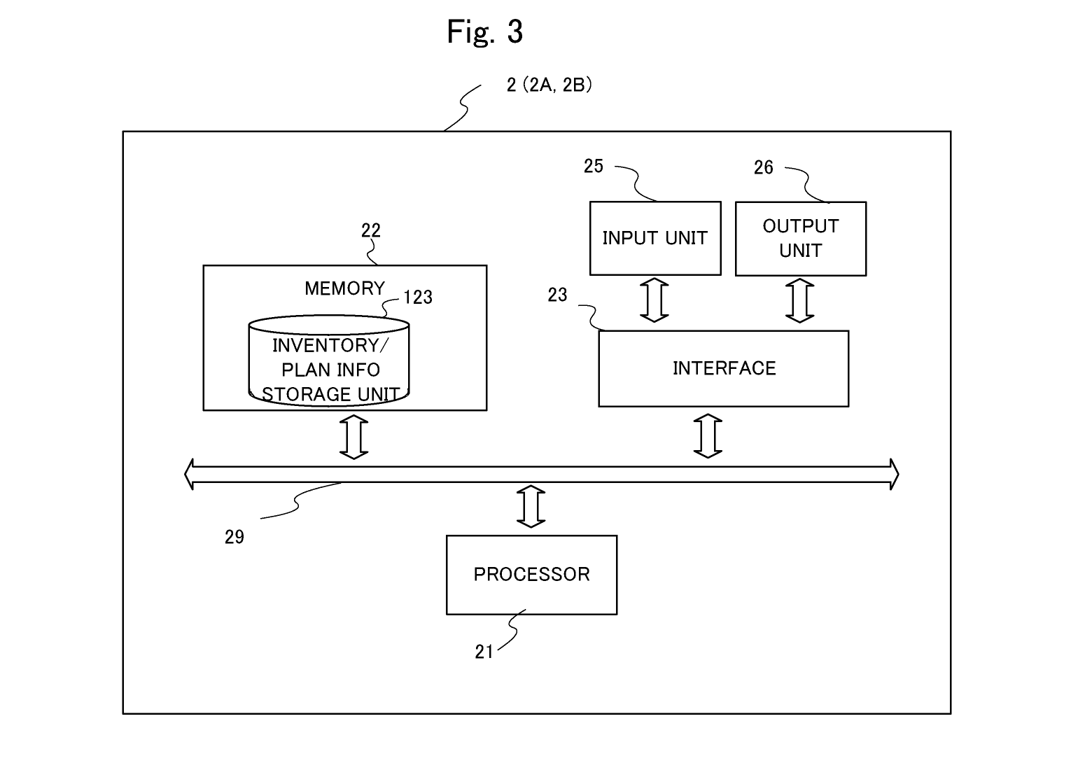

FIG. 3 illustrates a hardware configuration of the terminal device 2, that is, a hardware configuration common to the terminal device 2A and the terminal device 2B. The terminal device 2 includes a processor 21, a memory 22, and an interface 23 as hardware. The processor 21, the memory 22, and the interface 23 are connected via a data bus 29.

The processor 21 executes predetermined processing by executing a program stored in the memory 22. The processor 21 is a processor such as a CPU, a GPU, or a TPU. The processor 21 may include multiple processors. The processor 21 is an example of a computer.

The memory 22 includes various volatile memories and nonvolatile memories, such as a random access memory (RAM) and a read only memory (ROM). The memory 22 stores a program for the platform providing device 1 to execute various types of processing. The memory 22 is also used as a working memory.

Further, the memory 22 includes an inventory/plan information storage unit 123 that stores inventory/plan information on purchase and supply of items. The memory 22 of the terminal device 2A stores inventory/plan information of the negotiation subject A as a buyer, and the memory 22 of the terminal device 2B stores inventory/plan information of the negotiation subject B as a supplier. The inventory/plan information includes inventory information and production plan information of a product, inventory information and production plan information of parts necessary for manufacturing the product, and the like. The above inventory information includes, for each type of parts or products, prediction information of the quantity of stock planned to be supplied in the future in addition to the current quantity of stock. The production plan information is information indicating a production plan for each type of parts or products. The information stored in the inventory/plan information storage unit 123 is referred to by a person in charge who performs negotiations using the negotiation AI or manual negotiations in acceptance determination of an offer, generation of an offer, and the like. Here, the information stored in the inventory/plan information storage unit 123 may be stored in the memory 12 of the platform providing device 1 instead of the memory 22. In addition, the inventory/plan information may include a database that stores a past due date compliance rate, production capacity, and an inventory status of substitutes of the supplier. The inventory/plan information is referred to in the acceptance determination of an offer and the generation/update of an offer.

The interface 23 is an interface for electrically connecting the terminal device 2 and another device. This interface may be a wireless interface such as a network adapter for wirelessly transmitting and receiving data to and from the another device, or may be a hardware interface for connecting to the another device by a cable or the like.

In addition, the interface 23 performs an interface operation of an input unit 25 and an output unit 26. The input unit 25 is a user interface that accepts an input which is an external input, and is equivalent to, for example, a touch panel, a button, a keyboard, a voice input device, or the like. The interface 23 supplies an input signal, generated by the input unit 25, to another component in the terminal device 2 or a device outside the platform providing device 1. The output unit 26 displays or audio-outputs predetermined information based on an output signal supplied via the interface 23. Examples of the output unit 26 include a display, a projector, a voice output device, and the like.

A hardware configuration of the terminal device 2 is not limited to the configuration illustrated in FIG. 3. For example, at least one of the input unit 25 and the output unit 26 may be configured separately from the terminal device 2.

### Overview of Negotiation Platform

Next, an outline of the negotiation platform implemented by the platform providing device 1 will be described. Generally, when a supplier performs automatic negotiations by the negotiation AI, the negotiation AI of the supplier generates a counter offer in which, for an adjustment item for which the deliverable date cannot be fixed among adjustment items included in an offer provided by a buyer, the due date of this adjustment item is provisionally set to a provisional due date. In this case, the provisional due date is set to be a due date later than a realistic due date (for example, three years or more).

An advantage of setting the provisional due date will be described supplementarily. Generally, at the time when a supplier receives an offer from a buyer, the supplier may not have a prospect of satisfying the quantity and due date of a target item based on the offer, that is, the supplier may receive the offer exceeding a scheduled inventory quantity based on current inventory/plan information. Even in such a case, there is a possibility that the quantity and due date based on the offer of the target item can be satisfied by reflecting schedule information of the inventory quantity of the target item in the inventory/plan information in the near future. In such a case, by setting the due date of the target item as the provisional due date, the negotiation AI of the supplier can continue the negotiation for adjustment items other than the target item while substantially suspending the answer until obtaining delivery information of the target item. In addition, by supplying the buyer with a counter offer in which the due date of the target item is set to the provisional due date, the negotiation AI of the supplier can indicate, to the buyer, intention that the supplier is considering the adjustment item including the provisional due date.

On the other hand, in a case where a buyer performs automatic negotiations by the negotiation AI, the platform providing device 1 specifies, as a provisional due date, a due date later than a realistic due date included in an offer supplied from a supplier. Then, the platform providing device 1 generates a counter offer not including negotiations to delay the provisional due date. This enables the negotiation AI of the buyer to recognize that the supplier is considering the adjustment item for which the provisional due date is set, and continue the negotiation with the supplier for other adjustment items while avoiding unnecessary negotiation regarding the provisional due date.

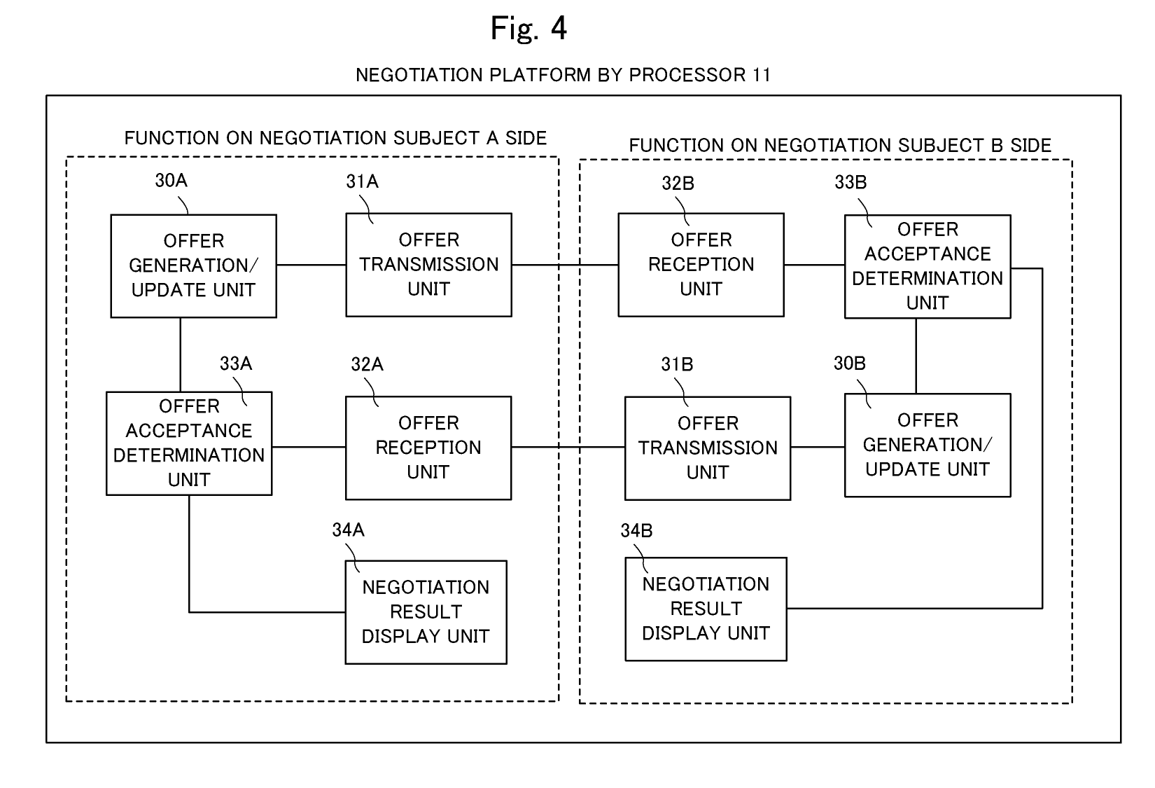

FIG. 4 is an example of functional blocks in the negotiation platform implemented by the processor 11 of the platform providing device 1. The negotiation platform includes, as functions on the side of the negotiation subject A, an offer generation/update unit 30A, an offer transmission unit 31A, an offer acceptance determination unit 33A, and a negotiation result display unit 34A. Meanwhile, the negotiation platform includes, as functions on the side of the negotiation subject B, an offer generation/update unit 30B, an offer transmission unit 31B, an offer acceptance determination unit 33B, and a negotiation result display unit 34B. While blocks that exchange data with each other are connected by a solid line in FIG. 4, a combination of the blocks that exchange data with each other is not limited to this. The same applies to diagrams of other functional blocks to be described later.

First, the functions on the side of the negotiation subject A will be described.

The offer generation/update unit 30A generates and updates an offer. To “update offer” refers to generation of a counter offer when an offer provided by the negotiation subject B cannot be accepted.

In the case of automatic negotiations by the negotiation AI, the processor 11 configures the negotiation AI with reference to model information stored in the model information storage unit 122, and executes processing related to the offer generation/update unit 30A. The negotiation AI generates an offer based on negotiation information, inventory/plan information, and the like. In addition, in a case where an offer received last by an offer reception unit 32A to be described later and a determination result indicating that the offer cannot be accepted are received from the offer acceptance determination unit 33A to be described later, the negotiation AI updates the received offer. Then, the offer generation/update unit 30A supplies the generated or updated offer to the offer transmission unit 31A.

In addition, the offer generation/update unit 30A determines whether the received offer includes a provisional due date, and in a case where the provisional due date is included, generates a counter offer that does not include negotiation to delay the provisional due date. In this case, for example, if there is a due date set to be a predetermined period (for example, three years) or more ahead of the current time among due dates included in the received offer, the offer generation/update unit 30A determines that this due date is a provisional due date. Here, information indicating the predetermined period is stored in advance in the memory 12, the memory 22, or the like. In another example, if a flag (also referred to as a “provisional flag”) indicating that the due date is a provisional due date is set to a specific adjustment item in the received offer, the offer generation/update unit 30A determines that the due date of the adjustment item is a provisional due date.

In the case of manual negotiations, the processor 11 functions as the offer generation/update unit 30A by controlling the terminal device 2A. For example, when receiving a determination result indicating that an offer cannot be accepted from the offer acceptance determination unit 33A, the offer generation/update unit 30A generates a counter offer based on information input by the negotiation subject A. In this case, the terminal device 2B accepts an input designating a counter offer, and transmits the accepted input information to the platform providing device 1. Further, the offer generation/update unit 30A may generate a new offer based on input information accepted at any timing.

Note that, even in the case of manual negotiations, the offer generation/update unit 30A may determine whether the received offer includes a provisional due date. In this case, if determining that the provisional due date is included, the offer generation/update unit 30A causes the terminal device 2B to accept a change from the received offer for adjustment items other than an adjustment item for which a provisional due date is designated, and generates a counter offer based on the accepted information. In this case, the offer generation/update unit 30A may cause the terminal device 2B to display that a supplier is suspending the answer for the adjustment item for which the provisional due date is designated and that it is not necessary to change the due date. In this case, for example, the offer generation/update unit 30A may deem that an order number including the provisional due date is suspended by the supplier, prohibit an input of an alternative plan, and accept an input of an alternative plan for other order numbers. This makes it possible to suitably suppress reception of an instruction to unnecessarily adjust the due date of the adjustment item for which the supplier is suspending the answer.

The offer transmission unit 31A supplies information, indicating an offer generated or updated by the offer generation/update unit 30A, to an offer reception unit 32B. In this case, for example, the processor 11 functions as the offer transmission unit 31A, generates display information for displaying the offer generated or updated by the offer generation/update unit 30A on the terminal device 2B, and transmits the generated display information to the terminal device 2B via the interface 13.

The offer reception unit 32A receives information indicating an offer supplied from the offer transmission unit 31B to be described later. In this case, for example, the processor 11 functions as the offer reception unit 32A and receives information indicating the offer supplied from the offer transmission unit 31B to be described later.

The offer acceptance determination unit 33A determines whether to accept (i.e., agree to) the offer received by the offer reception unit 32A.

In the case of automatic negotiations by the negotiation AI, the processor 11 configures the negotiation AI with reference to model information stored in the model information storage unit 122, and executes processing related to the offer acceptance determination unit 33A. If determining to agree to the offer received by the offer reception unit 32A, the offer acceptance determination unit 33A supplies information indicating the agreed offer (i.e., information indicating the offer received by the offer reception unit 32A) to the negotiation result display unit 34A. Note that, the offer acceptance determination unit 33A may also supply the information indicating the agreed offer to the negotiation result display unit 34B.

Here, even when an adjustment item for which an unrealistic due date is designated exists in the received offer because the received offer includes a provisional due date, the offer acceptance determination unit 33A performs acceptance determination of the received offer for all adjustment items including the adjustment item of the provisional due date. In this case, since the adjustment item for which an unrealistic due date is designated exists, the offer acceptance determination unit 33A determines not to accept the received offer.

In the case of manual negotiations, the offer acceptance determination unit 33A determines whether to accept (i.e., agree to) an offer received by the offer reception unit 32A based on information input by the negotiation subject A. In this case, the processor 11 functions as the offer acceptance determination unit 33A by controlling the terminal device 2A. Under control of the processor 11, the terminal device 2A displays the offer of the negotiation subject A based on the information received by the offer reception unit 32A, and accepts a user input that specifies whether to agree to the offer, whether to suspend negotiations, and the like. The terminal device 2A transmits the received input information to the platform providing device 1, and the processor 11 determines whether to accept (i.e., agree to) the offer based on the input information received from the terminal device 2A.

If determining not to be able to agree to the offer received by the offer reception unit 32A and determining that it is necessary to switch to manual negotiations, the offer acceptance determination unit 33A supplies information indicating the current offer to the negotiation result display unit 34A. Note that, the offer acceptance determination unit 33A may also supply the above information to the negotiation result display unit 34B. For example, in a case where there is no change between the offer received by the offer reception unit 32A last time and the offer received by the offer reception unit 32A the time before last (that is, in a case where there is no progress in negotiations), the offer acceptance determination unit 33A determines that it is necessary to switch to manual negotiations. In another example, the offer acceptance determination unit 33A determines that it is necessary to switch to manual negotiations in a case where there is a request to suspend negotiations from the negotiation subject B.

On the other hand, if determining not to be able to agree to the offer received by the offer reception unit 32A and determining that it is not necessary to switch to manual negotiations, the offer acceptance determination unit 33A supplies information indicating the received offer and a determination result indicating that the offer cannot be accepted to the offer generation/update unit 30A. Here, in a case where there is a change between the offer received by the offer reception unit 32A last time and the offer received by the offer reception unit 32A the time before last, the offer acceptance determination unit 33A determines that it is not necessary to switch to manual negotiations. In another example, the offer acceptance determination unit 33A determines that it is not necessary to switch to manual negotiations in a case where there is no request to suspend negotiations from the negotiation subject B.

The negotiation result display unit 34A causes the terminal device 2A to display the negotiation result based on the information received from the offer acceptance determination unit 33A. In this case, for example, the processor 11 functions as the negotiation result display unit 34A, generates display information based on the information received from the offer acceptance determination unit 33A, and supplies the generated display information to the terminal device 2A. For example, in a case where the offer is agreed, the negotiation result display unit 34A causes the terminal device 2A to display information regarding the agreed offer based on the information received from the offer acceptance determination unit 33A. The negotiation result display unit 34A may also cause the terminal device 2A to display a negotiation result based on information received from the offer acceptance determination unit 33B or the like when the offer acceptance determination unit 33B determines to suspend negotiations.

Next, the functions on the side of the negotiation subject B will be described.

The offer reception unit 32B receives information indicating an offer supplied from the offer transmission unit 31A. In this case, for example, the terminal device 2B functions as the offer reception unit 32B based on the control of the processor 11, and receives information, indicating the offer supplied from the offer transmission unit 31A, via the interface 23.

The offer acceptance determination unit 33B determines whether to accept (i.e., agree to) the offer received by the offer reception unit 32B.

In the case of automatic negotiations by the negotiation AI, the processor 11 configures the negotiation AI with reference to model information stored in the model information storage unit 122, and executes processing related to the offer acceptance determination unit 33B. If determining to agree to the offer received by the offer reception unit 32B, the offer acceptance determination unit 33B supplies information indicating the agreed offer (i.e., information indicating the offer received by the offer reception unit 32B) to the negotiation result display unit 34B. Note that, the offer acceptance determination unit 33B may also supply the information indicating the agreed offer to the negotiation result display unit 34A.

The offer acceptance determination unit 33B determines whether there is an adjustment item for which the specified quantity cannot be delivered no matter how late the due date is (so-called adjustment item with no solution) among adjustment items (including a set of the quantity and the due date) included in the received offer. For example, the offer acceptance determination unit 33B compares the quantity of each item included in the received offer with a scheduled inventory quantity based on current inventory/plan information of the item and, if there is an adjustment item that requests a quantity exceeding the scheduled inventory quantity, determines that there is no solution to the adjustment item. Then, if there is an adjustment item with no solution, the offer acceptance determination unit 33B determines not to be able to accept the received offer. Thereafter, the offer generation/update unit 30B generates a counter offer in which the due date of the adjustment item with no solution is set to a provisional due date.

In the case of manual negotiations, the offer acceptance determination unit 33B determines whether to accept (i.e., agree to) an offer received by the offer reception unit 32B based on information input by the negotiation subject B. In this case, the processor 11 functions as the offer acceptance determination unit 33B by controlling the terminal device 2B. In the acceptance determination of the offer, under control of the processor 11, the terminal device 2B displays the offer of the negotiation subject A based on the information received by the offer reception unit 32B, and accepts a user input that specifies whether to agree to the offer, whether to suspend negotiations, and the like. Then, the terminal device 2B transmits the received input information to the platform providing device 1, and the processor 11 determines whether to accept (i.e., agree to) the offer based on the input information received from the terminal device 2B.

If determining to agree to the offer, the offer acceptance determination unit 33B supplies information indicating the agreed offer (i.e., information indicating the offer received by the offer reception unit 32B) to the negotiation result display unit 34B. Meanwhile, if determining that there is no agreement on the entire offer and there is an input designating suspension of negotiations, the offer acceptance determination unit 33B determines that the negotiations should be suspended, and supplies information indicating the current offer to the negotiation result display unit 34B. Note that, the offer acceptance determination unit 33B may also supply the information, which is supplied to the negotiation result display unit 34B, to the negotiation result display unit 34A. Further, if there is no agreement on the offer and there is no input designating suspension of negotiations, the offer acceptance determination unit 33B supplies information indicating the offer and a determination result indicating that the offer cannot be accepted to the offer generation/update unit 30B.

The offer generation/update unit 30B generates and updates an offer. In the case of automatic negotiations by the negotiation AI, the processor 11 configures the negotiation AI with reference to model information stored in the model information storage unit 122, and executes processing related to the offer generation/update unit 30B. The negotiation AI generates an offer based on negotiation information, inventory/plan information, and the like. In addition, in a case where an offer received last by the offer reception unit 32B and a determination result indicating that the offer cannot be accepted are received from the offer acceptance determination unit 33B to be described later, the negotiation AI updates the received offer. Then, the offer generation/update unit 30B supplies the generated or updated offer to the offer transmission unit 31B.

Here, if the offer acceptance determination unit 33B determines that there is an adjustment item with no solution among adjustment items (including a set of the quantity and the due date) included in the received offer, the offer generation/update unit 30B generates a counter offer in which the due date of the adjustment item with no solution is set to a provisional due date. In this case, for example, the offer generation/update unit 30B sets the due date of the adjustment item with no solution to be ahead of a predetermined period. The predetermined period is set to be a period long enough not to be regarded as a realistic due date (for example, three years or more), and is stored in the memory 12 or the like in advance. In another example, the offer generation/update unit 30B sets a provisional flag indicating a provisional due date to a set (adjustment item) with no solution of the number of items to be delivered and the due date.

In the case of manual negotiations, the processor 11 functions as the offer generation/update unit 30B by controlling the terminal device 2B. For example, when receiving a determination result indicating that an offer cannot be accepted from the offer acceptance determination unit 33B, the offer generation/update unit 30B generates a counter offer based on information input by the negotiation subject B. In this case, the terminal device 2B accepts an input designating a counter offer, and transmits the accepted input information to the platform providing device 1. The offer generation/update unit 30B may accept an input specifying whether setting of a provisional due date is necessary for each adjustment item including a set of the quantity and the due date, and may generate a counter offer in which the due date of the adjustment item, for which an input that the provisional due date needs to be set has been made, is set to the provisional due date. In this case, the offer generation/update unit 30B generates a counter offer in which the due date of the adjustment item, for which an input that the provisional due date needs to be set has been made, is set to a due date that is a predetermined period or more ahead, or a counter offer in which a provisional flag is associated with the adjustment item for which an input that the provisional due date needs to be set has been made. Further, the offer generation/update unit 30B may generate a new offer based on input information accepted at any timing.

The offer transmission unit 31B supplies information, indicating an offer generated or updated by the offer generation/update unit 30B, to the offer reception unit 32A. For example, the processor 11 functions as the offer transmission unit 31B.

The negotiation result display unit 34B causes the terminal device 2B to display a negotiation result based on the information received from the offer acceptance determination unit 33B. In this case, for example, the processor 11 functions as the negotiation result display unit 34B, generates display information based on the information received from the offer acceptance determination unit 33B, and supplies the generated display information to the terminal device 2B. For example, in a case where the offer is agreed, the negotiation result display unit 34B causes the terminal device 2B to display information regarding the agreed offer based on the information received from the offer acceptance determination unit 33B. The negotiation result display unit 34B may also cause the terminal device 2B to display a negotiation result based on information received from the offer acceptance determination unit 33A or the like when the offer acceptance determination unit 33A determines to suspend negotiations.

Note that, each component of the offer generation/update unit 30A, the offer transmission unit 31A, the offer acceptance determination unit 33A, the negotiation result display unit 34A, the offer generation/update unit 30B, the offer transmission unit 31B, the offer acceptance determination unit 33B, and the negotiation result display unit 34B described in FIG. 4 can be implemented, for example, by causing the processor 11 to execute a program. Each component may be implemented in such a way that a required program is recorded in any nonvolatile storage medium and is installed as appropriate. At least a part of these components is not limited to be implemented by software by a program, and may be implemented by a combination of any of hardware, firmware, and software, or the like. At least a part of these components may be achieved using, for example, a user-programmable integrated circuit such as a field-programmable gate array (FPGA) or a microcontroller. In this case, a program including the above components may be implemented by using the integrated circuit. At least a part of the components may include an application specific standard product (ASSP), an application specific integrated circuit (ASIC), or a quantum processor (quantum computer control chip). In this manner, the components may be implemented by various types of hardware. The same applies to other example embodiments to be described later. These components may also be implemented by, for example, cooperation of multiple computers by using a cloud computing technology or the like.

### Offer including Provisional Due Date

Next, specific examples (a first specific example and a second specific example) regarding an offer including a provisional due date will be described.

First, the first specific example in which the negotiation subject B, which is a supplier, performs negotiations by the negotiation AI will be described. In the first specific example, the negotiation subject A, which is a buyer, performs either negotiations by the negotiation AI or manual negotiations.

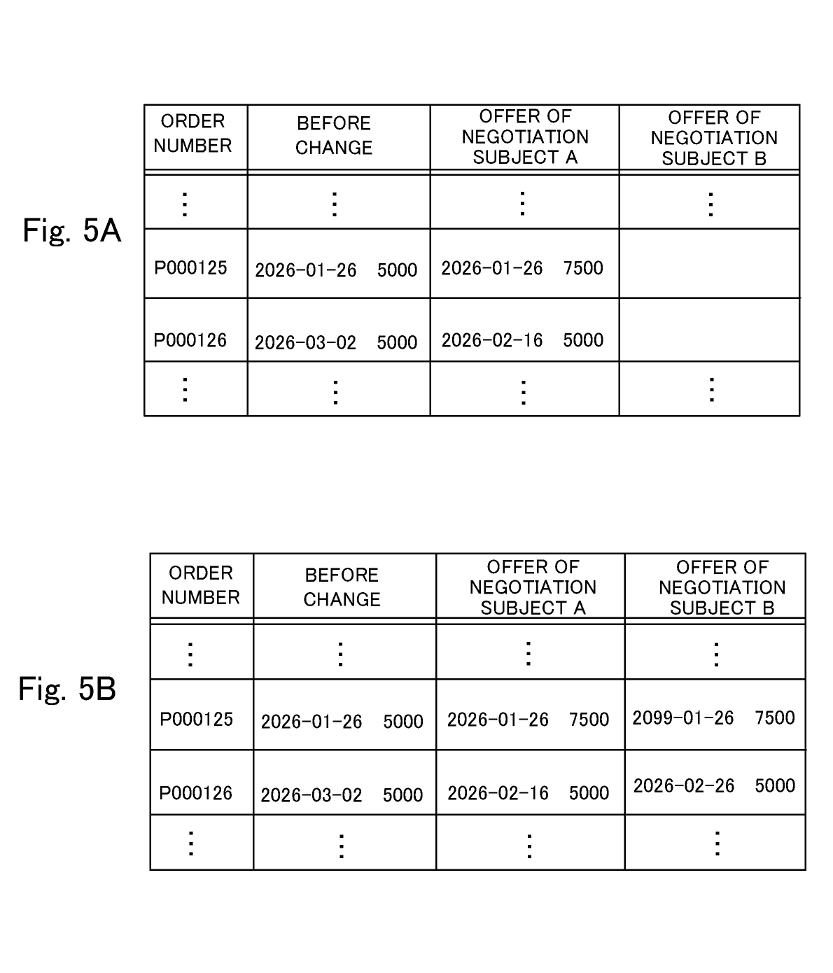

FIG. 5A is a table illustrating an offer history in the first specific example in which the negotiation subject A proposes an offer including order numbers “P000125” and “P000126” to the negotiation subject B. The table illustrated in FIG. 5A includes items of “order number”, “before change”, “proposal of negotiation subject A”, and “proposal of negotiation subject B”. The item “order number” indicates an order number assigned to an item to be delivered. The item “before change” indicates a draft agreement made before the negotiation subject A proposes an offer (that is, before negotiations). The item “proposal of negotiation subject A” indicates an offer proposed by the negotiation subject A. The item “proposal of negotiation subject B” indicates an offer proposed by the negotiation subject B. In this negotiation, the item “proposal of negotiation subject B” is blank since the negotiation subject B has not proposed an offer yet. Here, in each field of the items “before change”, “proposal of negotiation subject A”, and “proposal of negotiation subject B”, as an example, conditions regarding the due date (year-month-day) and the quantity of the item for each order number are indicated. However, any conditions such as price and transportation means may be further negotiated without being limited to the due date and the quantity.

In the first specific example, as illustrated in FIG. 5A, the quantity of the order number “P000125” is “5000” in the draft agreement before negotiations, whereas the quantity is increased to “7500” in the offer proposed by the negotiation subject A.

FIG. 5B is a table illustrating an offer history in the first specific example after a counter offer by the negotiation subject B is proposed. The negotiation AI representing the negotiation subject B refers to inventory/plan information of the negotiation subject B of the item corresponding to the order number “P000125” for which the quantity has been increased, and determines that an inventory quantity currently planned for the item is below the quantity “7500” in the received offer. Accordingly, in this case, the negotiation AI determines that the order number “P000125” is in a state in which the designated number of products to be delivered cannot be delivered no matter how much the due date is delayed (so-called a state with no solution). Thus, the negotiation AI sets the due date of the order number “P000125” to the provisional due date. Specifically, the negotiation AI sets the due date of the order number “P000125” to January 26, 2099, which is a due date a predetermined period or more ahead (that is, an unrealistic due date).

As described above, the negotiation subject B, which is a supplier, sets the due date of the order number “P000125” to the provisional due date since there is no solution at present. As a result, the negotiation subject B can indicate, to the negotiation subject A which is a buyer, that the order number “P000125” is under consideration and can continue negotiations for other order numbers with the negotiation subject A.

Next, the second specific example in which the negotiation subject A, which is a buyer, performs negotiations by the negotiation AI will be described. In the second specific example, assume that the negotiation subject B, which is a supplier, performs either negotiations by the negotiation AI or manual negotiations.

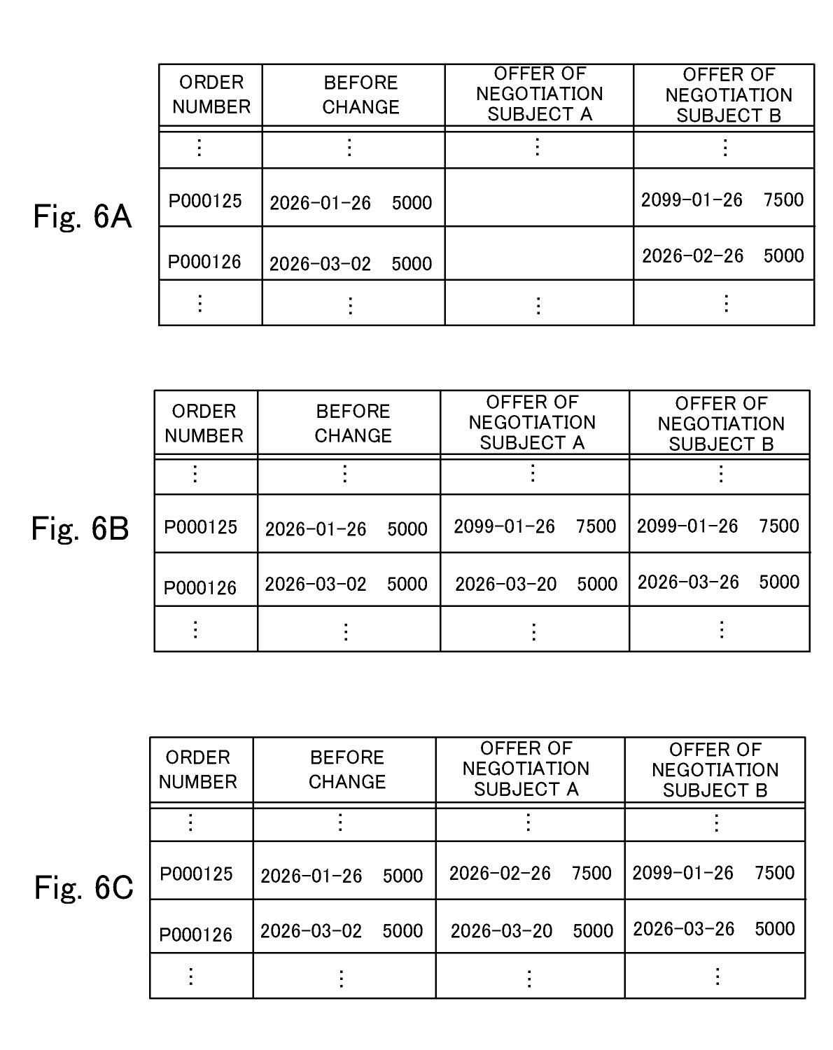

FIG. 6A is a table illustrating an offer history in the second specific example in which the negotiation subject B proposes an offer including order numbers “P000125” and “P000126” to the negotiation subject A. In the second specific example, the negotiation subject B supplies an offer including a provisional due date to the negotiation subject A. Specifically, as illustrated in FIG. 6A, the due date of the order number “P000125” is set to January 26, 2099, which is a due date that is a predetermined period or more ahead.

In this case, the negotiation AI representing the negotiation subject A performs acceptance determination of the offer, including the provisional due date supplied from the negotiation subject B, without considering whether it is the provisional due date. Here, the due date of the order number “P000125” is set to an unrealistic due date. Accordingly, the negotiation AI of the negotiation subject A refers to inventory/plan information of the negotiation subject A and the like, determines that the planned quantity of items of the order number “P000125” cannot be procured by the planned due date in the offer by the negotiation subject B, and thus does not accept the offer from the negotiation subject B. As described above, the negotiation AI of the negotiation subject A performs acceptance determination of the order number “P000125” while keeping the provisional due date to prevent acceptance of an offer including the provisional due date. Here, the negotiation AI of the negotiation subject A does not accept the offer also when determining that there is an order number with a provisional flag in the offer.

FIG. 6B is a table illustrating an offer history in the second specific example in a case where the negotiation AI of the negotiation subject A generates a counter offer.

In this case, since the due date of the order number “P000125” is set to January 26, 2099, which is a due date that is a predetermined period or more ahead, the negotiation AI of the negotiation subject A determines that the provisional due date is set for the order number “P000125”. Accordingly, the negotiation AI of the negotiation subject A does not generate a counter offer requesting a change of the due date based on the provisional due date for the order number “P000125”, and keeps the due date at the provisional due date for the order number “P000125”. Then, in a case where an offer from the negotiation subject B for an order number other than the order number “P000125” for which the provisional due date is set cannot be accepted, the negotiation AI of the negotiation subject A generates a counter offer indicating contents different from those of the offer. For example, in the offer from the negotiation subject B, the due date of the order number “P000126” is March 26, 2026 (that is, delayed from March 2, 2026 before negotiations). Then, the negotiation AI of the negotiation subject A refers to inventory/plan information and the like, determines that the due date of March 26, 2026 cannot be accepted in consideration of the plan, and sets a new due date of March 20, 2026 that is delayed but acceptable in consideration of the plan.

FIG. 6C is a table illustrating an offer history according to a comparative example of the second specific example in a case where the negotiation AI of the negotiation subject A generates a counter offer. In this comparative example, the negotiation AI of the negotiation subject A generates a counter offer without interpreting the due date of the order number “P000125”, which is intended to be a provisional due date by the negotiation subject B, as the provisional due date.

In the comparative example illustrated in FIG. 6C, the negotiation AI of the negotiation subject A determines that the offer of the negotiation subject B cannot be accepted because the due date of the order number “P000125” is set to January 26, 2099 not meeting the plan based on the inventory/plan information. Then, the negotiation AI of the negotiation subject A generates a counter offer in which the due date of February 26, 2026, which is an acceptable due date in consideration of the plan, is set for the order number “P000125”. As a result, the negotiation subject A proposes the delayed due date (February 26, 2026) with respect to the agreed due date (January 26, 2026) before negotiations for the order number “P000125”. As described above, in a case where the provisional due date is not appropriately interpreted, this causes the negotiation AI of the negotiation subject B to request a delayed due date, so that unnecessary due date negotiations occur. In addition, such a delayed due date request by the negotiation subject as a buyer does not conform to the spirit of the Act against Delay in Payment of Subcontract Proceeds, etc. to Subcontractors.

In consideration of the above, in the second specific example illustrated in FIG. 6B, the negotiation AI of the negotiation subject A appropriately specifies a due date, set a predetermined period or more ahead, as a provisional due date, and generates a counter offer not including due date negotiations for the provisional due date, thereby preventing unnecessary due date adjustment.

### Processing Flow

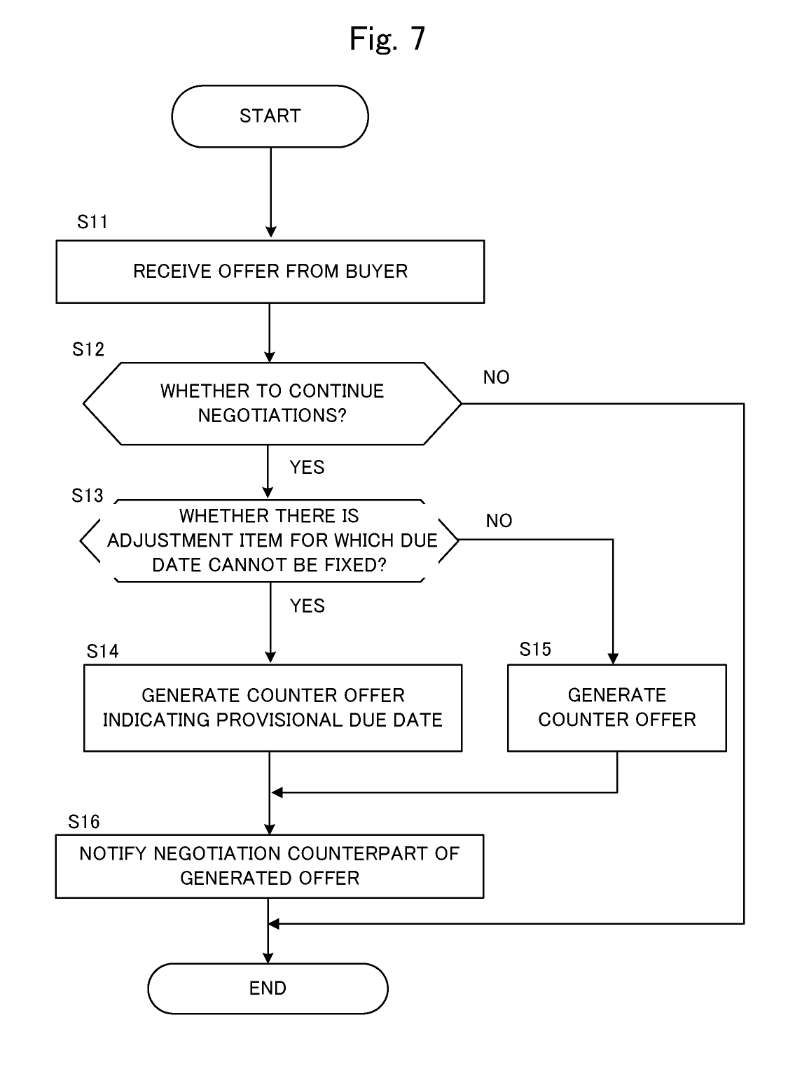

FIG. 7 is an example of a flowchart illustrating a procedure of processing related to acceptance determination of an offer and generation of a counter offer by the negotiation AI in a case where the negotiation subject B, which is a supplier, performs negotiations by the negotiation AI. Here, assume that the negotiation subject A, which is a buyer, performs either negotiations by the negotiation AI or manual negotiations.

First, the negotiation AI that performs automatic negotiations of the negotiation subject B receives an offer from the negotiation subject A that is a buyer (step S11). Then, the negotiation AI determines whether to continue negotiations based on the received offer (step S12). For example, the negotiation AI determines that the negotiations should be continued if determining that the received offer cannot be agreed and that the negotiations should not be suspended. On the other hand, the negotiation AI determines that the negotiations should not be continued if determining that the received offer should be agreed or if determining that the negotiations should be suspended. Here, if there is an adjustment item for which the due date cannot be fixed, the negotiation AI determines that the received offer cannot be agreed.

If determining that the negotiations should be continued (step S12; Yes), the negotiation AI determines whether an adjustment item for which the due date cannot be fixed (that is, an adjustment item with no solution) exists in the offer received in step S11 (step S13). In this case, if there is an adjustment item that requires a larger quantity than the scheduled inventory quantity based on the inventory/plan information of the negotiation subject B, the negotiation AI determines that the adjustment item for which the due date cannot be fixed exists in the received offer.

Then, if there is an adjustment item for which the due date cannot be fixed (step S13; Yes), the negotiation AI generates a counter offer indicating that the due date of the adjustment item is the provisional due date (step S14). In this case, the negotiation AI may set the due date of the adjustment item, for which the due date cannot be fixed, to a due date that is a predetermined period or more ahead, or may associate a provisional flag with the adjustment item. For each of adjustment items other than the adjustment item for which the due date cannot be fixed, based on the inventory/plan information of the negotiation subject B, the negotiation AI determines whether an alternative plan needs to be generated, generates an alternative plan of the adjustment item for which an alternative plan needs to be generated, and so forth. As a result, the negotiation AI generates a counter offer including multiple adjustment items. On the other hand, if there is no adjustment item for which the due date cannot be fixed (step S13; No), the negotiation AI determines that the provisional due date does not need to be set, and generates a counter offer (step S15). In this case, for each of adjustment items included in the received offer, based on the inventory/plan information of the negotiation subject B, the negotiation AI determines whether an alternative plan needs to be generated, generates an alternative plan of the adjustment item for which an alternative plan needs to be generated, and generates a counter offer including multiple adjustment items. Then, the negotiation AI notifies the negotiation counterpart of the generated counter offer (step S16).

On the other hand, if the negotiation AI determines that the negotiations should not be continued (step S12; No), the processing of the flowchart is ended. For example, if the negotiation AI agrees to the offer in step S11, the platform providing device 1 stores information indicating the offer agreed between the negotiation subjects in the negotiation information storage unit 121 in association with date and time information and the like when the agreement is made. In another example, if the negotiation AI determines that the negotiations should be suspended, the platform providing device 1 causes the terminal device 2A and the terminal device 2B to display the negotiation result.

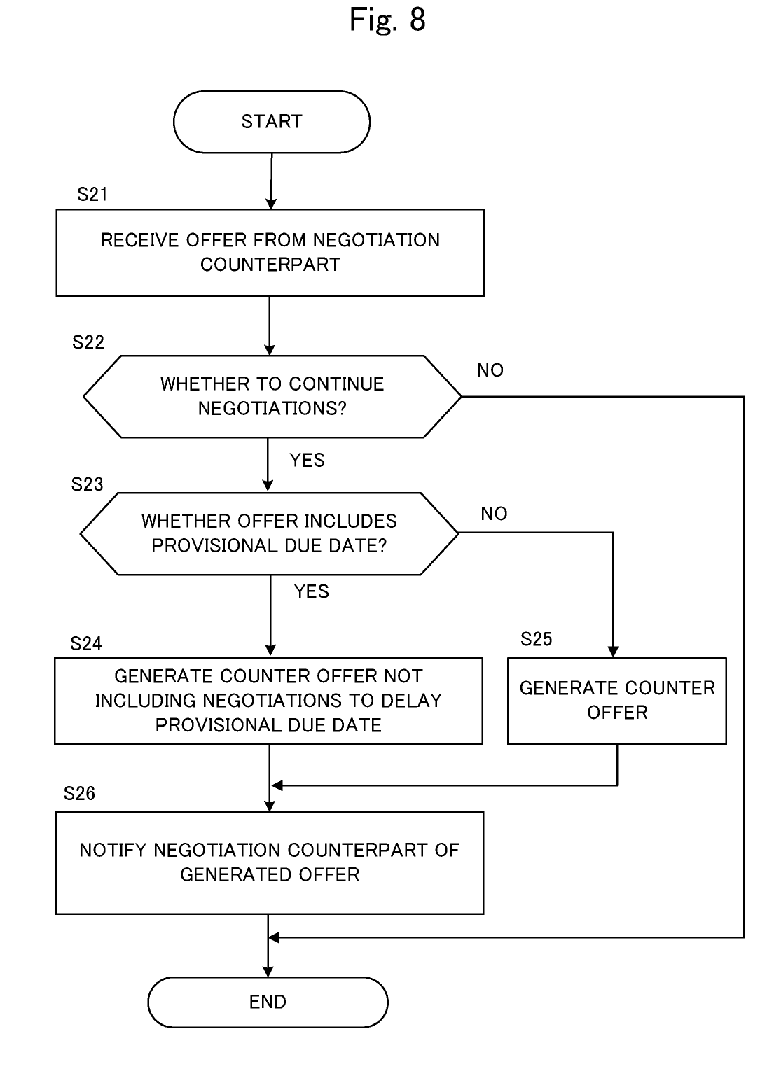

FIG. 8 is an example of a flowchart illustrating a procedure of processing related to acceptance determination of an offer and generation of a counter offer by the negotiation AI in a case where the negotiation subject A, which is a buyer, performs negotiations by the negotiation AI. Here, assume that the negotiation subject B, which is a supplier, performs either negotiations by the negotiation AI or manual negotiations.

First, the negotiation AI that performs automatic negotiations of the negotiation subject A receives an offer from the negotiation subject B that is a supplier (step S21). Then, the negotiation AI determines whether to continue negotiations based on the received offer (step S22). For example, the negotiation AI determines that the negotiations should be continued if determining that the received offer cannot be agreed and that the negotiations should not be suspended. On the other hand, the negotiation AI determines that the negotiations should not be continued if determining that the received offer should be agreed or if determining that the negotiations should be suspended. Here, the negotiation AI executes acceptance determination of the received offer regardless of whether the received offer includes a provisional due date.

If determining that the negotiations should be continued (step S22; Yes), the negotiation AI determines whether the received offer includes a provisional due date (step S23). For example, if a due date that is a predetermined period or more ahead is included in the offer, the negotiation AI specifies the due date as a provisional due date.

Then, if determining that the received offer includes the provisional due date (step S23; Yes), the negotiation AI generates a counter offer not including negotiations to delay the provisional due date (step S24). For example, the negotiation AI keeps the contents of the received offer for the order number including the provisional due date, and generates a counter offer indicating an alternative plan for an order number that cannot be accepted among other order numbers. On the other hand, if determining that the received offer does not include the provisional due date (step S23; No), the negotiation AI generates a counter offer for all adjustment items as adjustment targets (step S25). Then, the negotiation AI notifies the negotiation counterpart of the generated counter offer (step S26).

On the other hand, if the negotiation AI determines that the negotiations should not be continued (step S22; No), the processing of the flowchart is ended. For example, if the negotiation AI agrees to the offer in step S21, the platform providing device 1 stores information indicating the offer agreed between the negotiation subjects in the negotiation information storage unit 121 in association with date and time information and the like when the agreement is made. In another example, if the negotiation AI determines that the negotiations should be suspended, the platform providing device 1 causes the terminal device 2A and the terminal device 2B to display the negotiation result.

### Modified Example

Next, modified examples applicable to the above example embodiment will be described. The following modified examples may be applied in any combination.

### First Modified Example

Instead of being executed by the platform providing device 1, the negotiation AI may be executed by the terminal device 2 used by the negotiation subject that the negotiation AI works on its behalf.

In this case, the terminal device 2 of the negotiation subject using the negotiation AI stores model information, stored in the model information storage unit 122, in the memory 22, and the processor 21 of the terminal device 2 of the negotiation subject using the negotiation AI executes the negotiation AI by referring to the model information. Also in the present modified example, the automatic negotiations using the negotiation AI can be suitably implemented.

### Second Modified Example

The function of the platform providing device 1 may be incorporated in the terminal device 2.

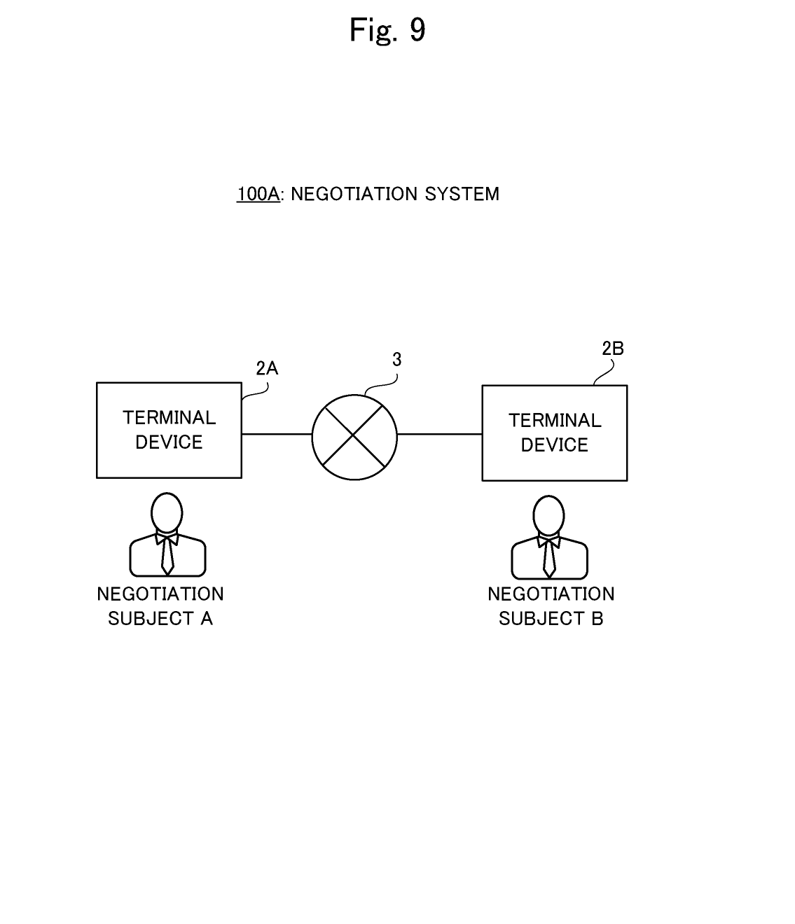

FIG. 9 illustrates a configuration of a negotiation system 100A. The negotiation system 100A includes a terminal device 2A usable by the negotiation subject A and a terminal device 2B usable by the negotiation subject B. The terminal device 2A and the terminal device 2B perform data communication via the network 3. Then, at least one of the terminal device 2A and the terminal device 2B implements a negotiation platform by executing processing executed by the platform providing device 1 illustrated in FIG. 1.

As illustrated in FIG. 9, also in an aspect in which data communication is performed between the terminal devices 2 used for negotiations, the terminal devices 2 can exchange information necessary for negotiations and suitably execute processing related to notification and acceptance of an offer.

### Second Example Embodiment

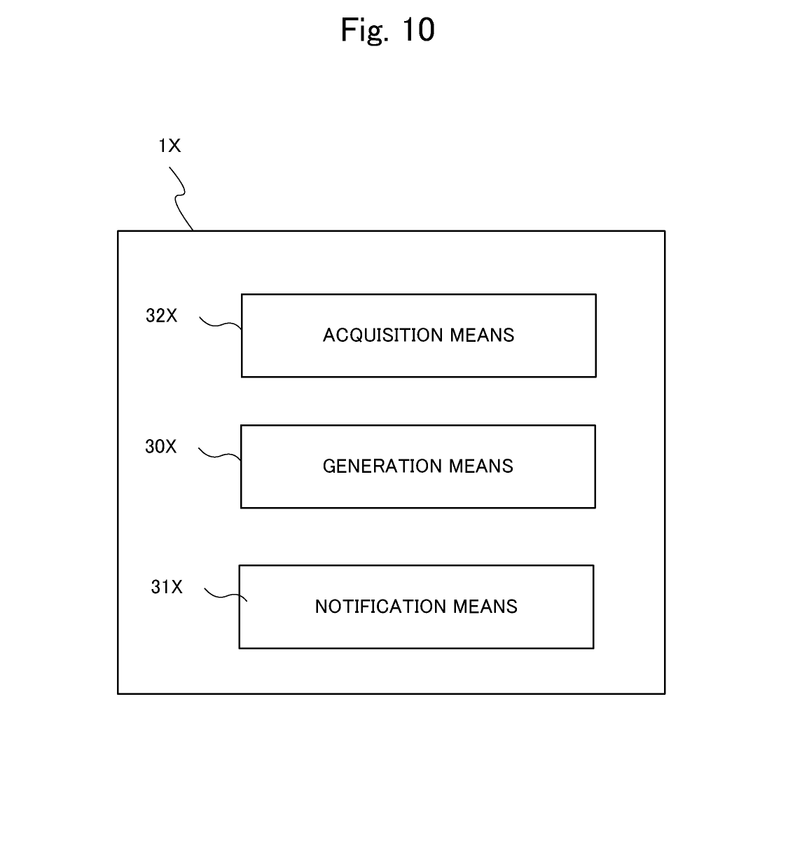

FIG. 10 is a functional block diagram of a negotiation support device 1X. The negotiation support device 1X mainly includes an acquisition means 32X, a generation means 30X, and a notification means 31X. The negotiation support device 1X may include multiple devices. The negotiation support device 1X may be, for example, either the platform providing device 1 illustrated in FIG. 1 or the terminal device 2A or the terminal device 2B executing the negotiation AI of the negotiation subject A in FIG. 9.

The acquisition means 32X acquires a first offer proposed by a first negotiation subject to a second negotiation subject. The acquisition means 32X may be, for example, the offer reception unit 32B in the first example embodiment.

The generation means 30X generates, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set. The generation means 30X may be, for example, the offer generation/update unit 30B in the first example embodiment.

The notification means 31X notifies the first negotiation subject of the second offer. The notification means 31X may be, for example, the offer transmission unit 31B in the first example embodiment.

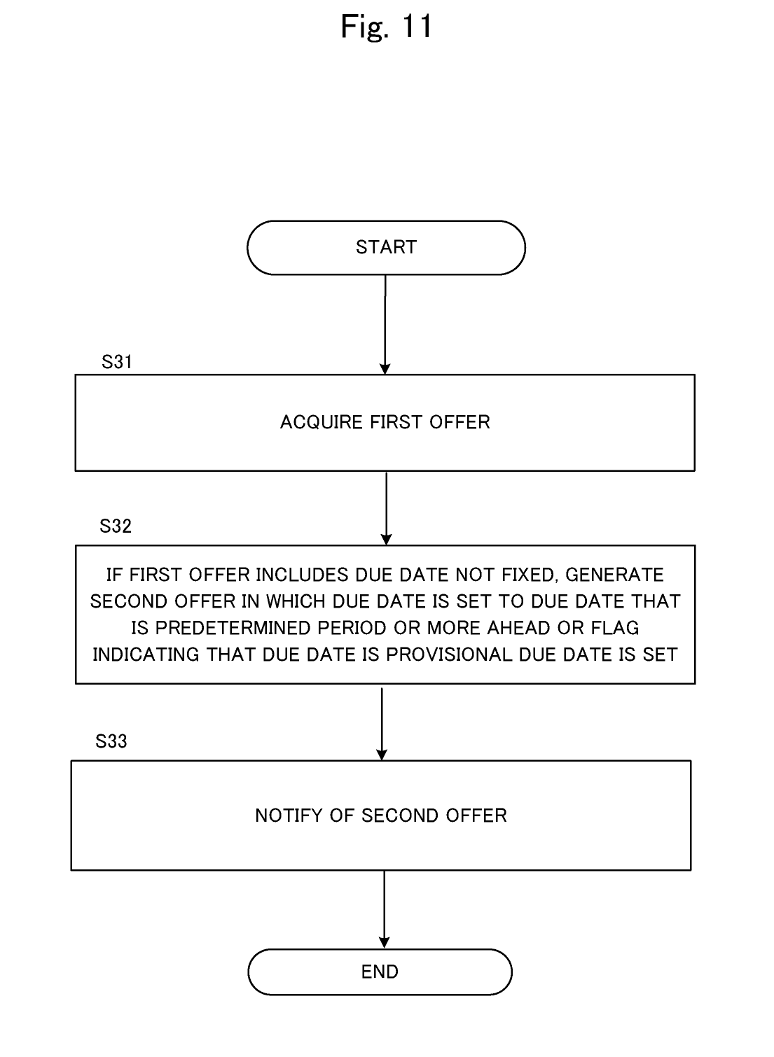

FIG. 11 is an example of a flowchart executed by the negotiation support device 1X. The acquisition means 32X acquires a first offer proposed by a first negotiation subject to a second negotiation subject (step S31). The generation means 30X generates, in a case where the first offer includes an adjustment item for which a deliverable date for the second negotiation subject is not able to be fixed, a second offer in which a due date of the adjustment item is set to a provisional due date that is a predetermined period or more ahead of current time or a flag indicating that the due date is a provisional due date is set (step S32). The notification means 31X notifies the first negotiation subject of the second offer (step S33).

The negotiation support device 1X according to the second example embodiment can, in a case where an offer presented by a negotiation counterpart includes an adjustment item for which a deliverable date is not able to be fixed, notify the negotiation counterpart of a counter offer that enables specifying that the due date of the adjustment item is a provisional due date.

In addition, a part or the whole of each of the above example embodiments (including modifications; the same applies hereinafter) may also be described as the following Supplementary Notes, but is not limited to the following. Furthermore, a part or the whole of the configurations described in Supplementary Notes 2 to 3 depending from the above-described Supplementary Note 1 may also depend from Supplementary Notes 9 and 11 by the same dependency as Supplementary Notes 2 to 3. Furthermore, a part or the whole of the configurations described in Supplementary Notes 5 to 8 depending from the above-described Supplementary Note 4 may also depend from Supplementary Notes 10 and 12 by the same dependency as Supplementary Notes 5 to 8. Further, not limited to the device, the method, and the storage medium described in the Supplementary Notes, a part or the whole of the configurations described as the Supplementary Notes may be similarly made dependent on a method, various hardware, software, various recording means for recording software (including a storage medium), or a system within a scope not departing from each of the above-described example embodiments.

### Supplementary Note 1

A negotiation support device comprising:
an acquisition means for acquiring a first offer proposed by a first negotiation subject to a second negotiation subject;
a generation means for generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and a notification means for notifying the first negotiation subject of the second offer.

### Supplementary Note 2

The negotiation support device according to Supplementary Note 1, wherein the first negotiation subject is a buyer who is supplied with an item, and the second negotiation subject is a supplier who supplies the item.

### Supplementary Note 3

The negotiation support device according to Supplementary Note 1, wherein, based on plan information regarding a stock of an item of the second negotiation subject, the generation means generates the second offer, in which the due date that is the predetermined period or more ahead is set or the flag is set, upon determining that a date when a quantity of the item presented in the first offer is deliverable is not able to be fixed.

### Supplementary Note 4

A negotiation support device comprising:
an acquisition means for acquiring an offer proposed by a second negotiation subject to a first negotiation subject; and
a specifying means for specifying, in a case where the offer includes an adjustment item for which a due date that is a predetermined period or more ahead of current time is set or an adjustment item for which a flag indicating that the due date is a provisional due date is set, that the provisional due date is set for the adjustment item.

### Supplementary Note 5

The negotiation support device according to Supplementary Note 4, further comprising
a determination means for performing acceptance determination of the offer, wherein
the determination means determines that the offer is not acceptable upon determining that the adjustment item for which the provisional due date is set is present.

### Supplementary Note 6

The negotiation support device according to Supplementary Note 5, further comprising
a generation means for generating an alternative offer that is an alternative of the offer when the determination means determines that the offer is not acceptable,
wherein the generation means generates the alternative offer not involving adjustment of the due date of the adjustment item for which the provisional due date is set.

### Supplementary Note 7

The negotiation support device according to Supplementary Note 6, wherein the offer includes a plurality of order numbers, and the generation means generates the alternative offer that adjusts contents of an order number other than the order number for which the provisional due date is set.

### Supplementary Note 8

The negotiation support device according to Supplementary Note 4, wherein the first negotiation subject is a buyer who is supplied with an item, and the second negotiation subject is a supplier who supplies the item.

### Supplementary Note 9

A method executed by a computer, comprising:
acquiring a first offer proposed by a first negotiation subject to a second negotiation subject;
generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and
notifying the first negotiation subject of the second offer.

### Supplementary Note 10

A method executed by a computer, comprising:
acquiring an offer proposed by a second negotiation subject to a first negotiation subject; and
specifying, in a case where the offer includes an adjustment item for which a due date that is a predetermined period or more ahead of current time is set or an adjustment item for which a flag indicating that the due date is a provisional due date is set, that the provisional due date is set for the adjustment item.

### Supplementary Note 11

A program causing a computer to execute a process comprising:
acquiring a first offer proposed by a first negotiation subject to a second negotiation subject;
generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set;
and notifying the first negotiation subject of the second offer.

### Supplementary Note 12

A program causing a computer to execute a process comprising:
acquiring an offer proposed by a second negotiation subject to a first negotiation subject; and
specifying, in a case where the offer includes an adjustment item for which a due date that is a predetermined period or more ahead of current time is set or an adjustment item for which a flag indicating that the due date is a provisional due date is set, that the provisional due date is set for the adjustment item.

### Supplementary Note 13

A storage medium storing a program according to Supplementary Note 11 or 12.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

DESCRIPTION OF REFERENCE NUMERALS
1 Platform providing device
1X Negotiation support device
2 (2A, 2B) Terminal device
3 Network
4 Storage device
100, 100A Negotiation system

What is claimed is:

1. A negotiation support device comprising:
at least one memory configured to store instructions; and
at least one processor configured to execute the instructions to:
acquire a first offer proposed by a first negotiation subject to a second negotiation subject;
generate, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and
notify the first negotiation subject of the second offer.

2. The negotiation support device according to claim 1, wherein the first negotiation subject is a buyer who is supplied with an item, and the second negotiation subject is a supplier who supplies the item.

3. The negotiation support device according to claim 1, wherein, based on plan information regarding a stock of an item of the second negotiation subject, the at least one processor is configured to execute the instructions to generate the second offer, in which the due date that is the predetermined period or more ahead is set or the flag is set, upon determining that a date when a quantity of the item presented in the first offer is deliverable is not able to be fixed.

4. A negotiation support device comprising:
at least one memory configured to store instructions; and
at least one processor configured to execute the instructions to:
acquire an offer proposed by a second negotiation subject to a first negotiation subject; and
specify, in a case where the offer includes an adjustment item for which a due date that is a predetermined period or more ahead of current time is set or an adjustment item for which a flag indicating that the due date is a provisional due date is set, that the provisional due date is set for the adjustment item.

5. The negotiation support device according to claim 4, wherein the at least one processor is configured to further execute the instructions to
perform acceptance determination of the offer, and
determine that the offer is not acceptable upon determining that the adjustment item for which the provisional due date is set is present.

6. The negotiation support device according to claim 5, wherein the at least one processor is configured to further execute the instructions to
generate an alternative offer that is an alternative of the offer upon determining that the offer is not acceptable, and
generate the alternative offer not involving adjustment of the due date of the adjustment item for which the provisional due date is set.

7. A method executed by a computer, comprising:
acquiring a first offer proposed by a first negotiation subject to a second negotiation subject;
generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set; and
notifying the first negotiation subject of the second offer.

8. A method executed by a computer, comprising:
acquiring an offer proposed by a second negotiation subject to a first negotiation subject; and
specifying, in a case where the offer includes an adjustment item for which a due date that is a predetermined period or more ahead of current time is set or an adjustment item for which a flag indicating that the due date is a provisional due date is set, that the provisional due date is set for the adjustment item.

9. A non-transitory computer readable storage medium storing a program causing a computer to execute a process comprising:
acquiring a first offer proposed by a first negotiation subject to a second negotiation subject;
generating, in a case where the first offer includes an adjustment item for which a deliverable date for the second negotiation subject is not able to be fixed, a second offer in which a due date of the adjustment item is set to a due date that is a predetermined period or more ahead of current time or a flag indicating that the due date is a provisional due date is set;
and notifying the first negotiation subject of the second offer.

10. A non-transitory computer readable storage medium storing a program causing a computer to execute a process comprising:
acquiring an offer proposed by a second negotiation subject to a first negotiation subject; and
specifying, in a case where the offer includes an adjustment item for which a due date that is a predetermined period or more ahead of current time is set or an adjustment item for which a flag indicating that the due date is a provisional due date is set, that the provisional due date is set for the adjustment item.
